(19) United States
(12) Patent Application Publication
(10) Pub. No.: US 2017/0242559 A1
(43) Pub. Date: Aug. 24, 2017

(54) AUTOMATION OF APPLICATION CREATION UTILIZING FLEXIBLE FRAMEWORKS

(71) Applicant: salesforce.com, inc., San Francisco, CA (US)

(72) Inventors: Stephen L. Pepper, Highlands Ranch, CO (US); Christopher Jolley, Lone Tree, CO (US); Purushotham Babu Naidu, Lafayette, CO (US); Francois Lopitaux, San Francisco, CA (US); Mandy Louise Blumreich, Longmont, CO (US); Kari L. Hotchkiss, Denver, CO (US)

(21) Appl. No.: 15/046,801

(22) Filed: Feb. 18, 2016

(51) Int. Cl. G06F 3/0484; G06F 3/0482; G06F 17/21; G06F 17/24

(52) U.S. Cl. CPC G06F 3/0484; G06F 17/248; G06F 3/0482; G06F 17/211

(57) ABSTRACT

Techniques for providing a custom app. One or more options for configuring features of an app to be generated based on an application template file that describes a generic app having a plurality of features of different types are provided via a graphical user interface. At least one application template file is modified based on one or more inputs received via the graphical user interface to select from the plurality of features to be included in the app. Code is automatically generated to provide the app having the features configured via the graphical user interface.

### TECHNICAL FIELD

Embodiments relate to techniques and architectures for creation and/or maintenance of application(s). More particularly, embodiments relate to a flexible framework and architecture to support custom creation of one or more applications that can provide, for example, analytical tools.

### BACKGROUND

When individuals/organizations/multitenant clients have large amounts of data, it is common for the data to be stored on devices that belong to different environments. For example, an organization may have a large amount of data stored in a multitenant database environment and other data (e.g., legacy data) stored in a database that is not part of the multitenant database environment. Analyzing and utilizing this data can be complex and time-consuming. Specifically, creation of analytical tools can be difficult and expensive.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a conceptual block diagram of one embodiment of an analytic app that can be utilized and/or created using the techniques described herein.

FIG. 2 is a graphical representation of an example dashboard that can provide analytical information via a graphical user interface of an electronic device.

FIG. 3 is a block diagram of one embodiment of an electronic system.

FIG. 4 is one embodiment of a graphical user interface that can be utilized to support automated application creation.

FIG. 5 is a first of multiple screens provided via a graphical user interface to allow a user to generate an app utilizing a flexible app creation framework.

FIG. 6 is a second of multiple screens provided via a graphical user interface to allow a user to generate an app utilizing a flexible app creation framework.

FIG. 7 is an example naming screen to allow a user to name a generated app.

FIG. 8 is one embodiment of an environment in which the app can be deployed.

FIG. 9 illustrates a block diagram of an environment where an on-demand database service might be used.

FIG. 10 illustrates a block diagram of an environment where an on-demand database service might be provided.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

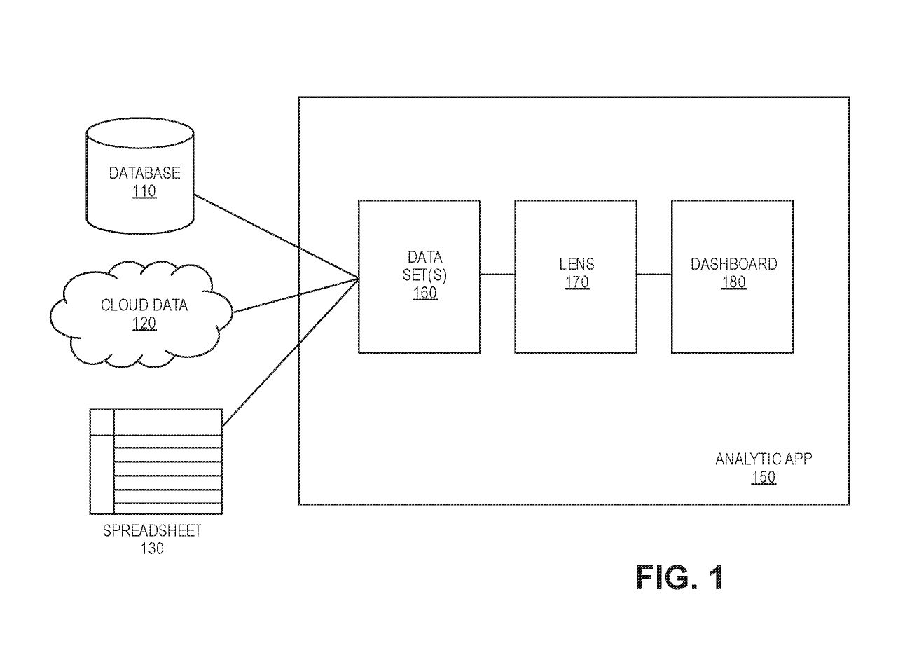

FIG. 1 is a conceptual block diagram of one embodiment of an analytic app that can be utilized and/or created using the techniques described herein. The example of FIG. 1 is based on an analytic app (e.g., an app that examines raw data and provides conclusions and/or graphical representations of the data); however, other uses for data can also be supported. An “app” is generally a self-contained program or piece of software designed to fulfill a particular purpose (e.g., data analytics). The app can be executed by any type of electronic device, for example, a smartphone, a laptop computer, a tablet, a desktop computer, a wearable computing device, etc.

A dataset is a specific view into one or more data sources (e.g., database 110, cloud data 120, spreadsheet 130) based on selection parameters. Analytic app 150 operates on data set(s) 160 to provide analytical operations on data set(s) 160. In one embodiment, at least one data source (e.g., database 110 and/or cloud data 120) is a key-value pair store that supports any type of data whether structured or unstructured.

In one embodiment, analytic app 150 can provide one or more lenses 170 that can provide visualization and/or exploratory analysis of data set(s) 160. In one embodiment, a lens provides exploration of one or more data sets using one or more fundamental operations including measuring (e.g., value), grouping (e.g., ownership, category), filtering and/or viewing (e.g., bar chart, line graph).

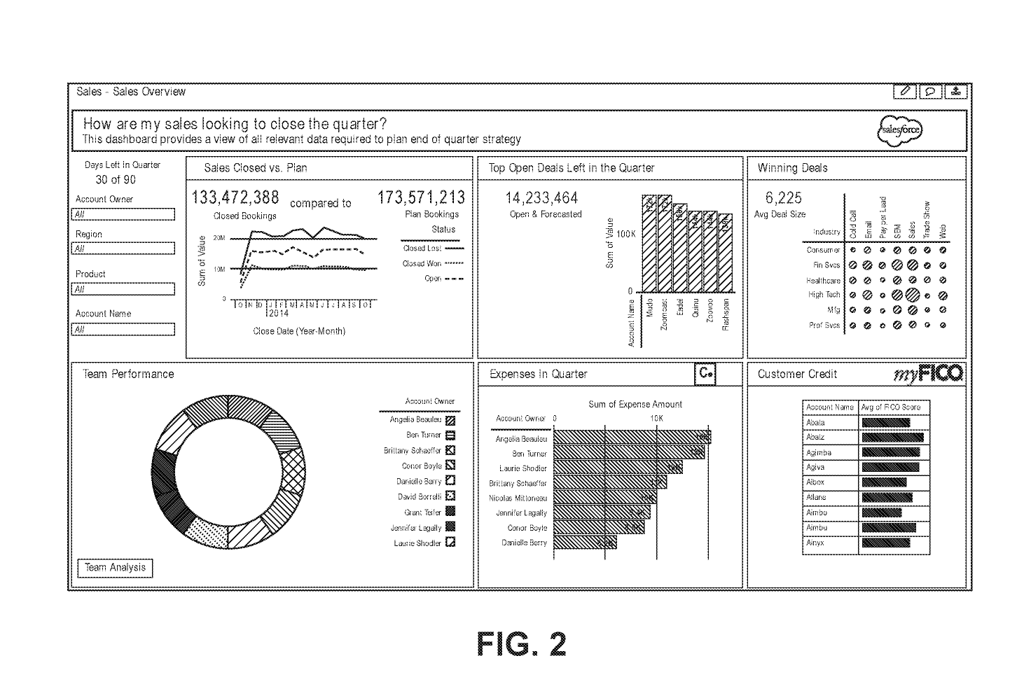

In one embodiment, a dashboard is an interactive interface with information from one or more lenses. In one embodiment, dashboard 180 provides analytical information about data set(s) 160 via a graphical user interface of an electronic device (e.g., a screen of a smartphone or tablet, a display device coupled with a computing platform, a projector). One graphical example of a dashboard is provided in FIG. 2.

FIG. 2 is a graphical representation of an example dashboard that can provide analytical information via a graphical user interface of an electronic device. In one embodiment, a conversion/data acquisition process is performed to acquire data from one or more sources to create data set(s) 160. In one embodiment, a JavaScript Object Notation (JSON)-based mechanism is used to create data set(s) 160. In other embodiments, other mechanisms, (e.g., Extensible Markup Language, XML) can be used to create data set(s) 160. JSON is a text-based, human-readable data interchange format that can be used to represent data structures and/or objects in browser-based code.

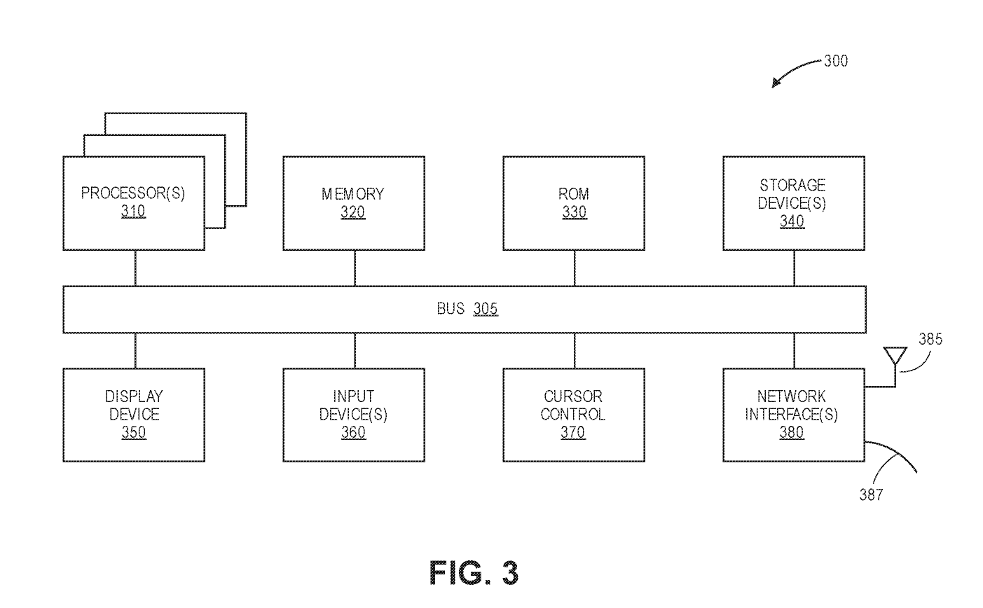

FIG. 3 is a block diagram of one embodiment of an electronic system. The electronic system illustrated in FIG. 3 is intended to represent a range of electronic systems (either wired or wireless) including, for example, desktop computer systems, laptop computer systems, cellular telephones, smartphones, tablets, wearable computing devices, etc. Alternative electronic systems may include more, fewer and/or different components. The electronic system of FIG. 3 can, for example, execute analytic app 150 and/or provide the graphical user interface discussed with respect to FIG. 2.

Electronic system 300 includes bus 305 or other communication device to communicate information, and processor 310 coupled to bus 305 that may process information. While electronic system 300 is illustrated with a single processor, electronic system 300 may include multiple processors and/or co-processors. Electronic system 300 further may include random access memory (RAM) or other dynamic storage device 320 (referred to as memory), coupled to bus 305 and may store information and instructions that may be executed by processor 310. Memory 320 may also be used to store temporary variables or other intermediate information during execution of instructions by processor 310.

Electronic system 300 may also include read only memory (ROM) and/or other static storage device 330 coupled to bus 305 that may store static information and instructions for processor 310. Data storage device 340 may be coupled to bus 305 to store information and instructions. Data storage device 340 such as a magnetic disk or optical disc and corresponding drive may be coupled to electronic system 300.

Electronic system 300 may also be coupled via bus 305 to display device 350, such as a liquid crystal display (LCD), plasma screen or other interface, to display information to a user. Alphanumeric input device 360, including alphanumeric and other keys, may be coupled to bus 305 to communicate information and command selections to processor 310. Another type of user input device is cursor control 370, such as a mouse, a trackball, or cursor direction keys to communicate direction information and command selections to processor 310 and to control cursor movement on display device 350.

Electronic system 300 further may include network interface(s) 380 to provide access to a network, such as a local area network. Network interface(s) 380 may include, for example, a wireless network interface having antenna 385, which may represent one or more antenna(e). Network interface(s) 380 may also include, for example, a wired network interface to communicate with remote devices via network cable 387, which may be, for example, an Ethernet cable, a coaxial cable, a fiber optic cable, a serial cable, or a parallel cable.

In one embodiment, network interface(s) 380 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 380 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

Techniques described herein allow a streamlined process for creating an app that provides analytical capabilities as described above. The techniques described herein can also be utilized to streamline the process for creating other types of apps, but the examples provided herein are generally focused on analytics apps. In one embodiment, the streamlined process utilizes a framework and a set of rules that results in creation of an app that operates on and/or provides one or more datasets, lenses and dashboards.

In one embodiment, a user (or other entity) is presented with a graphical user interface through which selections are made to determine a set of actions to be performed by the app to be created. In one embodiment, the framework is based on a JSON structure that is modified based on responses provided by the configuring entity. In other embodiments, other frameworks (e.g., XML) can be supported.

In one embodiment, for example, a user can be provided with a graphical user interface in which questions are answered with respect to the desired functionality of the app to be created. In response to the answers, the host electronic system can modify the JSON structure to customize the features/functionality to be provided by the app. For example, if a user answers “No” to a question, the JSON node/path associated with that functionality can be deleted from the file, which can be utilized to customize the app.

As another example, nodes within the JSON file can be added, substituted or modified in response to the answers provided. In one embodiment, creation of the app occurs asynchronously after completion of all or some of the questions provided via the interface. In other embodiments, nodes can be added in response to the answers provided.

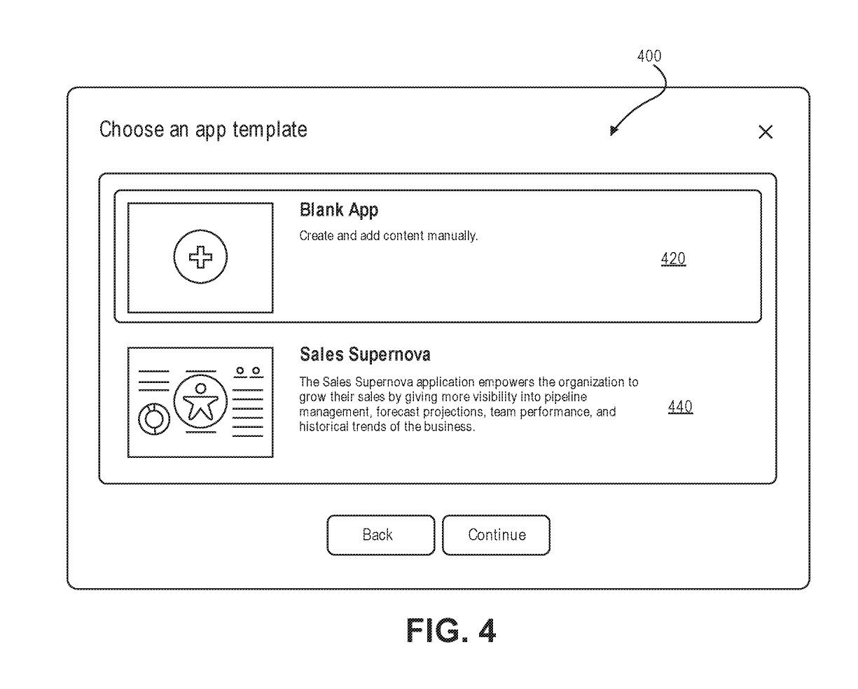

FIG. 4 is one embodiment of a graphical user interface that can be utilized to support automated application creation. In one embodiment, the graphical user interface illustrated in FIG. 4 can be provided via the electronic system of FIG. 3. In one embodiment, initial screen 400 provided by the graphical user interface can allow a user to select the process of creating an app manually and creating content manually (e.g., Blank App 420) or the user can select to work with a flexible framework to create an app (e.g., Sales Supernova 440).

In one embodiment, the automated application creation interface provides a wizard that allows the user to customize the application that is going to be generated. Customizations can include, for example, overriding default field values, choosing a color for charts, features to enable/disable dashboard components, uploading datasets, providing login and/or password interfaces (e.g., to an external system, integration with an external system).

In one embodiment, the app design and generation is performed via a “wizard” that presents a series of questions that are used to generate a customized app based on the responses to the questions. The examples that follow provide a few of the types of questions that can be utilized to generate a customized app.

As described below, an app definition can be wholly or partially based the responses provided. In one embodiment, an application generation server provides a representational state transfer (REST) end-point that operates to create a customized app using one or more of: an app template, a dashboard template, a lens template, a dataset template, a data flow template, and a JSON file.

In one embodiment, the JSON file provides a set of actions to be performed and the file contents can be modified based on the responses provided through the wizard (or other interface). In one embodiment, a generic dashboard (or lens) JSON file can include all features, but can be modified based on input from the user. For example, if a user answers “no” to a question presented by the configuration wizard the corresponding path and/or node in the JSON file can be deleted or modified. Thus, at a high level, a user is provided with questions via a user interface that results in a substitution in a template file (e.g., a JSON variable file) that is used with a declarative wizard to generate an app.

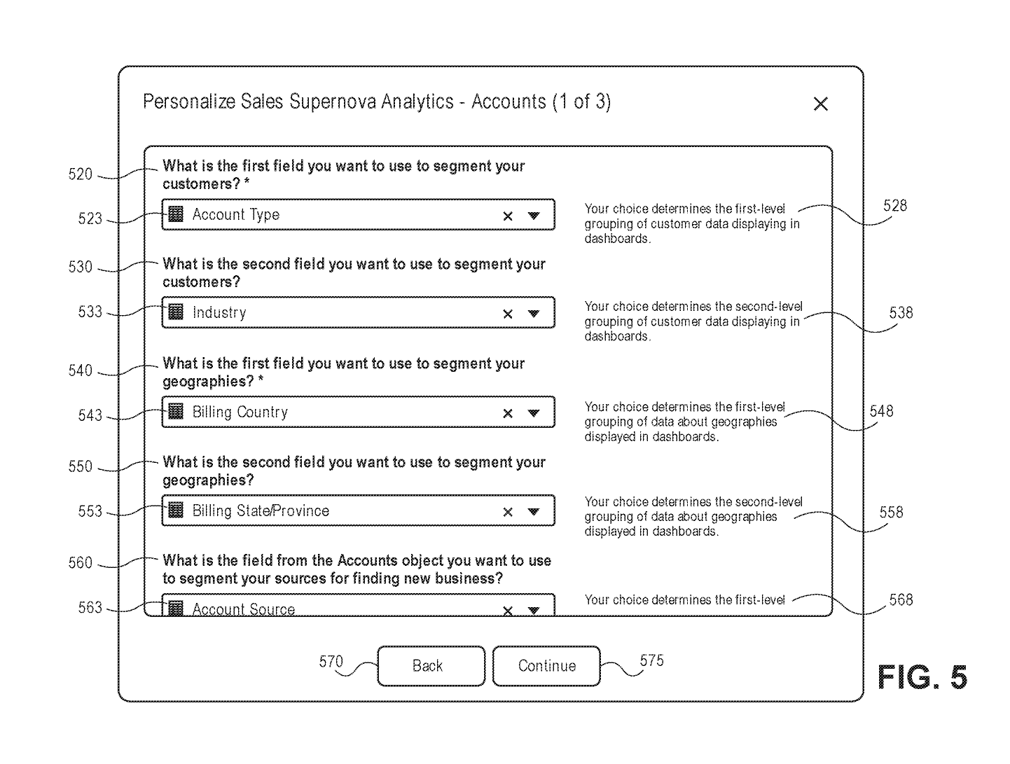

FIG. 5 is a first of multiple screens provided via a graphical user interface to allow a user to generate an app utilizing a flexible app creation framework. The example of FIGS. 5-7 is based on an example having three personalization screens; however, any number of screens and/or steps can be supported.

In the example of FIG. 5, a user is presented with several questions with corresponding dropdown menus. The example of FIG. 5 is just one example and different questions and/or different selection options (e.g., buttons, text fields) can also be used. In the example of FIG. 5, the questions provided are directed to account configuration; however, other and/or different question types can also be supported.

For example, question 520 (“What is the first filed you want to use to segment your customers?) can be associated with dropdown 523 that allows a user to select, for example, account types to be the first field used to segment customers. In one embodiment, description 528 provides additional information for the user in making a selection based on question 520.

The example of FIG. 5 can include any number of questions (e.g., 530, 540, 550, 560), corresponding dropdowns (e.g., 533, 543, 553, 563) and descriptions (e.g., 538, 548, 558, 568). The interface can further include navigation elements (e.g., back button 570 and continue button 575).

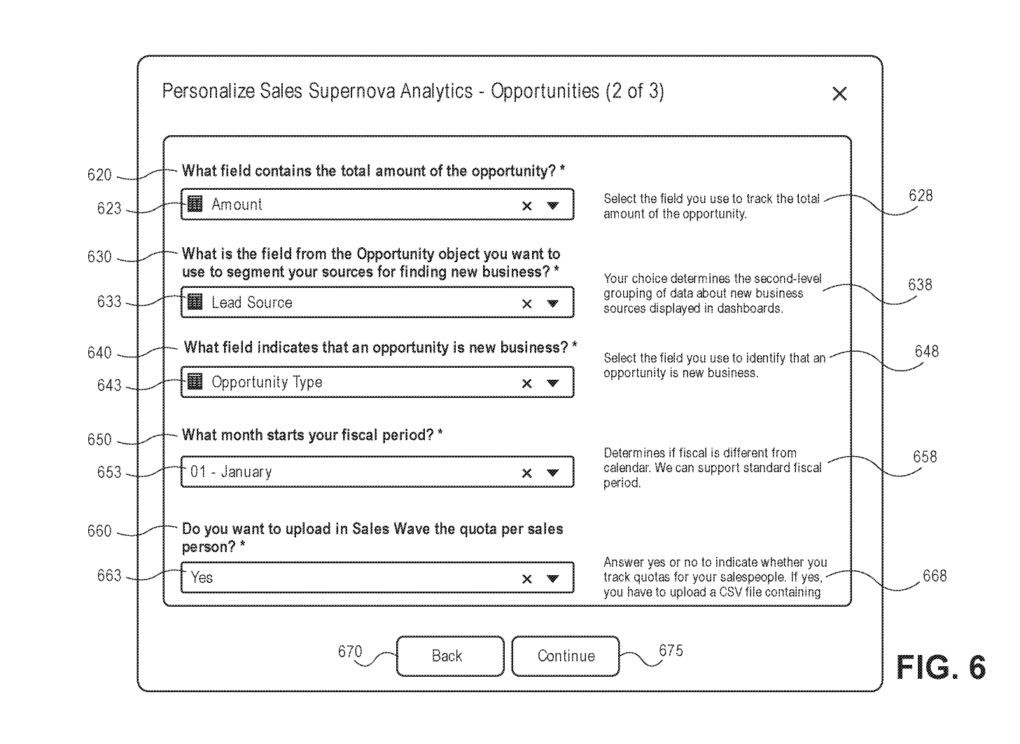

FIG. 6 is a second of multiple screens provided via a graphical user interface to allow a user to generate an app utilizing a flexible app creation framework. In the example of FIG. 6, a user is presented with several questions with corresponding dropdown menus. In the example of FIG. 6, the questions provided are directed to opportunity management configuration; however, other and/or different question types can also be supported.

For example, question 620 (“What field contains the total amount of the opportunity?) can be associated with dropdown 623 that allows a user to select, for example, amount types to be the first field used to segment customers. In one embodiment, description 628 provides additional information for the user in making a selection based on question 620.

The example of FIG. 6 can include any number of questions (e.g., 630, 640, 650, 660), corresponding dropdowns (e.g., 633, 643, 653, 663) and descriptions (e.g., 638, 648, 658, 668). The interface can further include navigation elements (e.g., back button 670 and continue button 675).

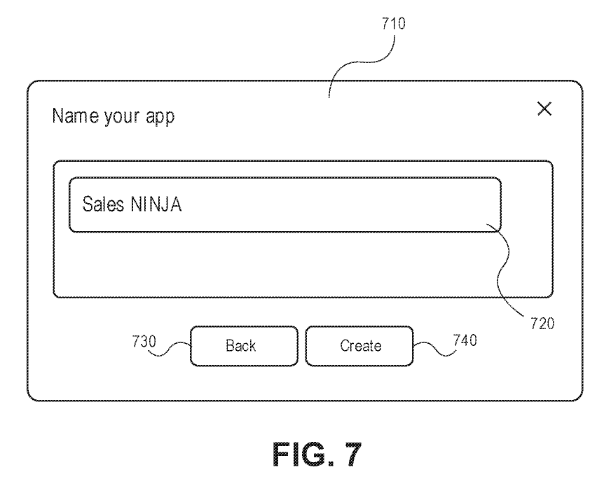

FIG. 7 is an example naming screen to allow a user to name a generated app. In one embodiment, naming screen 710 provides at least field 720 to name the app (e.g., Sales Ninja). In one embodiment, naming screen 710 can include navigation buttons (e.g., back button 730 and create button 740). Other and/or different elements can also be provided in naming screen 710.

In one embodiment, apps are generated asynchronously. Through the process described above (or a similar process) information is gathered to configure the desired app. The wizard process generates a payload that is provided to a server computing device that generates and compiled the code to provide the app. In one embodiment, after receiving the payload, the server waits for dataset completions, if necessary, and/or dependency resolutions, if necessary, prior to compiling the code for the app.

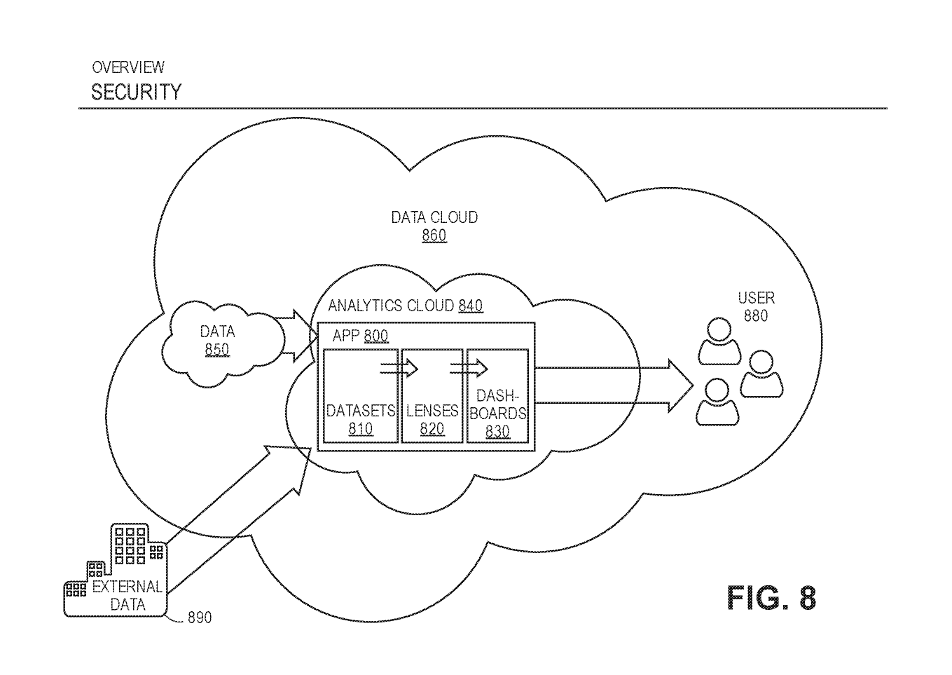

FIG. 8 is one embodiment of an environment in which the app can be deployed. The concepts described herein can be utilized to generate an app for use in any environment; however, a cloud-based example is provided in FIG. 8.

In one embodiment, app 800 is an app generated as described herein. App 800 can have access to and/or control dataset(s) 810. In one embodiment, dataset owners control access to records in the dataset(s). Dataset(s) 810 provide data to lens(es) 820 as described above. Lens(es) 820 operate with dashboard(s) 830 as described above. Dashboard(s) provide information to one or more users 880 via one or more electronic devices (not illustrated in FIG. 8). In one embodiment, app owners, administrators and users granted manager access to an app control access to datasets, lenses and dashboards within the app.

In one embodiment, app 800 operates within analytics cloud 840, which can be a subset of larger data cloud 860. In one embodiment, analytics cloud 840 can provide features and/or functionality that is targeted to users doing analytics work on data 850 from data cloud 860 and/or external data 890. In one embodiment, data cloud 860 and/or analytics cloud 840 are multitenant environments. In one embodiment, a tenant includes a group of users who share a common access with specific privileges to a software instance.

A multi-tenant architecture provides a tenant with a dedicated share of the software instance typically including one or more of tenant specific data, user management, tenant-specific functionality, configuration, customizations, non-functional properties, associated applications, etc. Multi-tenancy contrasts with multi-instance architectures, where separate software instances operate on behalf of different tenants.

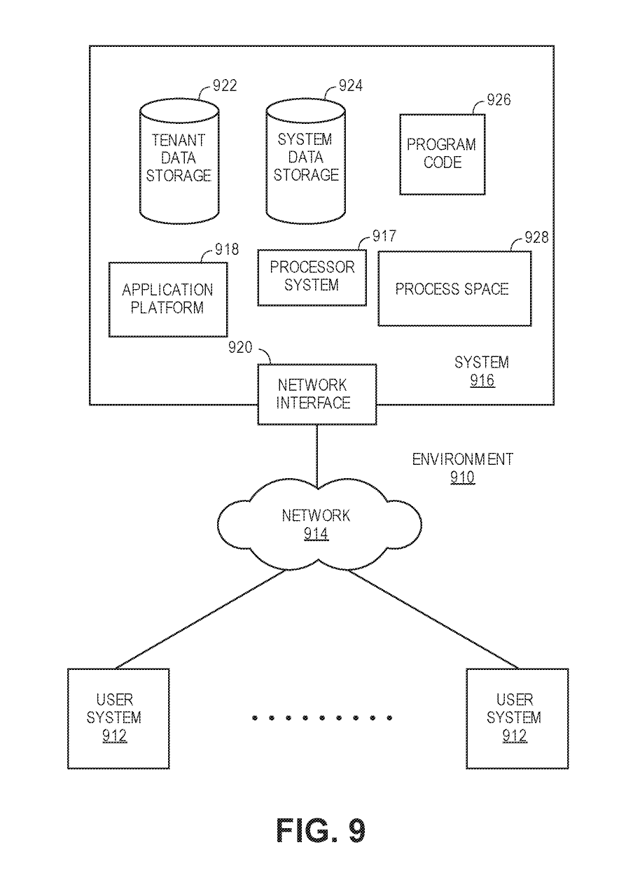

FIG. 9 illustrates a block diagram of an environment 910 wherein an on-demand database service might be used. Environment 910 may include user systems 912, network 914, system 916, processor system 917, application platform 918, network interface 920, tenant data storage 922, system data storage 924, program code 926, and process space 928. In other embodiments, environment 910 may not have all of the components listed and/or may have other elements instead of, or in addition to, those listed above.

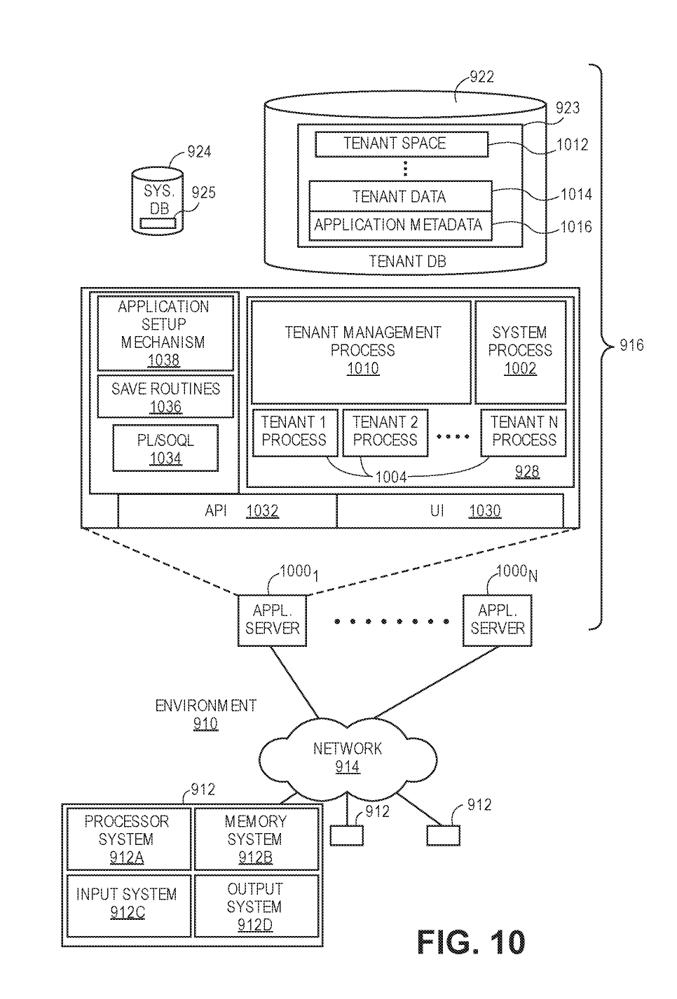

Environment 910 is an environment in which an on-demand database service exists. User system 912 may be any machine or system that is used by a user to access a database user system. For example, any of user systems 912 can be a handheld computing device, a mobile phone, a laptop computer, a work station, and/or a network of computing devices. As illustrated in herein FIG. 9 (and in more detail in FIG. 10) user systems 912 might interact via a network 914 with an on-demand database service, which is system 916.

An on-demand database service, such as system 916, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 916” and “system 916” will be used interchangeably herein. A database image may include one or more database objects. A relational database management system (RDMS) or the equivalent may execute storage and retrieval of information against the database object(s). Application platform 918 may be a framework that allows the applications of system 916 to run, such as the hardware and/or software, e.g., the operating system. In an embodiment, on-demand database service 916 may include an application platform 918 that enables creation, managing and executing one or more applications developed by the provider of the on-demand database service, users accessing the on-demand database service via user systems 912, or third party application developers accessing the on-demand database service via user systems 912.

The users of user systems 912 may differ in their respective capacities, and the capacity of a particular user system 912 might be entirely determined by permissions (permission levels) for the current user. For example, where a salesperson is using a particular user system 912 to interact with system 916, that user system has the capacities allotted to that salesperson. However, while an administrator is using that user system to interact with system 916, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 914 is any network or combination of networks of devices that communicate with one another. For example, network 914 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 912 might communicate with system 916 using TCP/IP and, at a higher network level, use other common Internet protocols to communicate, such as HTTP, FTP, AFS, WAP, etc. In an example where HTTP is used, user system 912 might include an HTTP client commonly referred to as a “browser” for sending and receiving HTTP messages to and from an HTTP server at system 916. Such an HTTP server might be implemented as the sole network interface between system 916 and network 914, but other techniques might be used as well or instead. In some implementations, the interface between system 916 and network 914 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 916, shown in FIG. 9, implements a web-based customer relationship management (CRM) system. For example, in one embodiment, system 916 includes application servers configured to implement and execute CRM software applications as well as provide related data, code, forms, webpages and other information to and from user systems 912 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 916 implements applications other than, or in addition to, a CRM application. For example, system 916 may provide tenant access to multiple hosted (standard and custom) applications, including a CRM application. User (or third party developer) applications, which may or may not include CRM, may be supported by the application platform 918, which manages creation, storage of the applications into one or more database objects and executing of the applications in a virtual machine in the process space of the system 916.

One arrangement for elements of system 916 is shown in FIG. 9, including a network interface 920, application platform 918, tenant data storage 922 for tenant data 923, system data storage 924 for system data 925 accessible to system 916 and possibly multiple tenants, program code 926 for implementing various functions of system 916, and a process space 928 for executing MTS system processes and tenant-specific processes, such as running applications as part of an application hosting service. Additional processes that may execute on system 916 include database indexing processes.

Several elements in the system shown in FIG. 9 include conventional, well-known elements that are explained only briefly here. For example, each user system 912 could include a desktop personal computer, workstation, laptop, PDA, cell phone, or any wireless access protocol (WAP) enabled device or any other computing device capable of interfacing directly or indirectly to the Internet or other network connection. User system 912 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 912 to access, process and view information, pages and applications available to it from system 916 over network 914. Each user system 912 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 916 or other systems or servers. For example, the user interface device can be used to access data and applications hosted by system 916, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 912 and all of its components are operator configurable using applications, such as a browser, including computer code run using a central processing unit such as an Intel Pentium® processor or the like. Similarly, system 916 (and additional instances of an MTS, where more than one is present) and all of their components might be operator configurable using application(s) including computer code to run using a central processing unit such as processor system 917, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 916 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 916 is configured to provide webpages, forms, applications, data and media content to user (client) systems 912 to support the access by user systems 912 as tenants of system 916. As such, system 916 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 10 also illustrates environment 910. However, in FIG. 10 elements of system 916 and various interconnections in an embodiment are further illustrated. FIG. 10 shows that user system 912 may include processor system 912A, memory system 912B, input system 912C, and output system 912D. FIG. 10 shows network 914 and system 916. FIG. 10 also shows that system 916 may include tenant data storage 922, tenant data 923, system data storage 924, system data 925, User Interface (UI) 1030, Application Program Interface (API) 1032, PL/SOQL 1034, save routines 1036, application setup mechanism 1038, applications servers 1000₁-400_{N}, system process space 1002, tenant process spaces 1004, tenant management process space 1010, tenant storage space 1012, tenant data 1014, and application metadata 1016. In other embodiments, environment 910 may not have the same elements as those listed above and/or may have other elements instead of, or in addition to, those listed above.

User system 912, network 914, system 916, tenant data storage 922, and system data storage 924 were discussed above in FIG. 9. Regarding user system 912, processor system 912A may be any combination of one or more processors. Memory system 912B may be any combination of one or more memory devices, short term, and/or long term memory. Input system 912C may be any combination of input devices, such as one or more keyboards, mice, trackballs, scanners, cameras, and/or interfaces to networks. Output system 912D may be any combination of output devices, such as one or more monitors, printers, and/or interfaces to networks. As shown by FIG. 10, system 916 may include a network interface 920 (of FIG. 9) implemented as a set of HTTP application servers 1000, an application platform 918, tenant data storage 922, and system data storage 924. Also shown is system process space 1002, including individual tenant process spaces 1004 and a tenant management process space 1010. Each application server 1000 may be configured to tenant data storage 922 and the tenant data 923 therein, and system data storage 924 and the system data 925 therein to serve requests of user systems 912. The tenant data 923 might be divided into individual tenant storage spaces 1012, which can be either a physical arrangement and/or a logical arrangement of data. Within each tenant storage space 1012, tenant data 1014 and application metadata 1016 might be similarly allocated for each user. For example, a copy of a user's most recently used (MRU) items might be stored to tenant data 1014. Similarly, a copy of MRU items for an entire organization that is a tenant might be stored to tenant storage space 1012. A UI 1030 provides a user interface and an API 1032 provides an application programmer interface to system 916 resident processes to users and/or developers at user systems 912. The tenant data and the system data may be stored in various databases, such as one or more Oracle™ databases.

Application platform 918 includes an application setup mechanism 1038 that supports application developers' creation and management of applications, which may be saved as metadata into tenant data storage 922 by save routines 1036 for execution by subscribers as one or more tenant process spaces 1004 managed by tenant management process 1010 for example. Invocations to such applications may be coded using PL/SOQL 1034 that provides a programming language style interface extension to API 1032. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 1016 for the subscriber making the invocation and executing the metadata as an application in a virtual machine.

Each application server 1000 may be communicably coupled to database systems, e.g., having access to system data 925 and tenant data 923, via a different network connection. For example, one application server 1000₁ might be coupled via the network 914 (e.g., the Internet), another application server 1000_{N-1} might be coupled via a direct network link, and another application server 1000_{N} might be coupled by yet a different network connection. Transfer Control Protocol and Internet Protocol (TCP/IP) are typical protocols for communicating between application servers 1000 and the database system. However, it will be apparent to one skilled in the art that other transport protocols may be used to optimize the system depending on the network interconnect used.

In certain embodiments, each application server 1000 is configured to handle requests for any user associated with any organization that is a tenant. Because it is desirable to be able to add and remove application servers from the server pool at any time for any reason, there is preferably no server affinity for a user and/or organization to a specific application server 1000. In one embodiment, therefore, an interface system implementing a load balancing function (e.g., an F5 Big-IP load balancer) is communicably coupled between the application servers 1000 and the user systems 912 to distribute requests to the application servers 1000. In one embodiment, the load balancer uses a least connections algorithm to route user requests to the application servers 1000. Other examples of load balancing algorithms, such as round robin and observed response time, also can be used. For example, in certain embodiments, three consecutive requests from the same user could hit three different application servers 1000, and three requests from different users could hit the same application server 1000. In this manner, system 916 is multi-tenant, wherein system 916 handles storage of, and access to, different objects, data and applications across disparate users and organizations.

As an example of storage, one tenant might be a company that employs a sales force where each salesperson uses system 916 to manage their sales process. Thus, a user might maintain contact data, leads data, customer follow-up data, performance data, goals and progress data, etc., all applicable to that user's personal sales process (e.g., in tenant data storage 922). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 916 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 916 might also maintain system level data usable by multiple tenants or other data. Such system level data might include industry reports, news, postings, and the like that are sharable among tenants.

In certain embodiments, user systems 912 (which may be client systems) communicate with application servers 1000 to request and update system-level and tenant-level data from system 916 that may require sending one or more queries to tenant data storage 922 and/or system data storage 924. System 916 (e.g., an application server 1000 in system 916) automatically generates one or more SQL statements (e.g., one or more SQL queries) that are designed to access the desired information. System data storage 924 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A non-transitory computer-readable medium having stored thereon sequences of instructions that, when executed by one or more hardware processing devices, are configurable to cause the hardware processing devices to:
present, via a graphical user interface, one or more options for configuring features of an app to be generated based on an application template file that describes a generic app having a plurality of features of different types, wherein the graphical user interface comprises at least one graphical element corresponding to features that can be selected;
modify, with the one or more hardware processing devices, at least one application template file based on one or more inputs received via the graphical user interface to select from the plurality of features to be included in the app;
generate code, with the one or more hardware processing devices, to provide the app having the features configured via the graphical user interface.

2. The non-transitory computer-readable medium of claim 1 wherein the graphical user interface provides a series of questions to determine the one or more options for configuring the features of the app.

3. The non-transitory computer-readable medium of claim 1 further comprising instructions that, when executed by the one or more hardware processing devices, are configurable to cause the hardware processing devices to:
receive, with the one or more hardware processing devices, a payload file describing the features of the app;
wait, after receiving the payload, for dataset completions, if necessary;
wait, after receiving the payload, for dependency resolutions, if necessary;
compile, with the one or more hardware processing devices, the code for the app after dataset completions, if any, and after dependency resolutions, if any.

4. The non-transitory computer-readable medium of claim 3 wherein the payload file comprises a text-based, human-readable data interchange format file.

5. The non-transitory computer-readable medium of claim 1 further comprising instructions that, when executed by the one or more hardware processing devices, are configurable to cause the hardware processing devices to deploy the app within a multitenant environment.

6. The non-transitory computer-readable medium of claim 1 further comprising instructions that, when executed by the one or more hardware processing devices, are configurable to cause the hardware processing devices to:
provide one or more lenses within the app, wherein the one or more lenses provide exploration of one or more data sets using one or more fundamental operations including at least measuring, grouping, filtering and viewing; and
provide one or more dashboards within the app, wherein the one or more dashboards provide an interactive interface with information from the one or more lenses.

7. A method for providing an automated app creation framework, the method comprising:
presenting, via a graphical user interface, one or more options for configuring features of an app to be generated based on an application template file that describes a generic app having a plurality of features of different types, wherein the graphical user interface comprises at least one graphical element corresponding to features that can be selected;
modifying, with the one or more hardware processing devices, at least one application template file based on one or more inputs received via the graphical user interface to select from the plurality of features to be included in the app;
generating code, with the one or more hardware processing devices, to provide the app having the features configured via the graphical user interface.

8. The method of claim 7 wherein the graphical user interface provides a series of questions to determine the one or more options for configuring the features of the app.

9. The method of claim 7 further comprising:
receiving, with the one or more hardware processing devices, a payload file describing the features of the app;
waiting, after receiving the payload, for dataset completions, if necessary;
waiting, after receiving the payload, for dependency resolutions, if necessary;
compiling, with the one or more hardware processing devices, the code for the app after dataset completions, if any, and after dependency resolutions, if any.

10. The method of claim 9 wherein the payload file comprises a text-based, human-readable data interchange format file.

11. The method of claim 7 further comprising deploying the app within a multitenant environment.

12. The method of claim 7 further comprising:
providing one or more lenses within the app, wherein the one or more lenses provide exploration of one or more data sets using one or more fundamental operations including at least measuring, grouping, filtering and viewing; and
providing one or more dashboards within the app, wherein the one or more dashboards provide an interactive interface with information from the one or more lenses.

13. A system configurable to provide an automated app creation framework, the method comprising:
a memory device;
one or more hardware processors coupled with the memory device, the one or more hardware processors configurable to present, via a graphical user interface, one or more options for configuring features of an app to be generated based on an application template file that describes a generic app having a plurality of features of different types, wherein the graphical user interface comprises at least one graphical element corresponding to features that can be selected, to modify, with the one or more hardware processing devices, at least one application template file based on one or more inputs received via the graphical user interface to select from the plurality of features to be included in the app, and to generate code, with the one or more hardware processing devices, to provide the app having the features configured via the graphical user interface.

14. The system of claim 13 wherein the graphical user interface is configurable to provide a series of questions to determine the one or more options for configuring the features of the app.

15. The system of claim 13 wherein the one or more hardware processors is configurable to receive, a payload file describing the features of the app, to wait, after receiving the payload, for dataset completions, if necessary, to wait, after receiving the payload, for dependency resolutions, if necessary, and to compile, with the one or more hardware processing devices, the code for the app after dataset completions, if any, and after dependency resolutions, if any.

16. The system of claim 15 wherein the payload file comprises a text-based, human-readable data interchange format file.

17. The system of claim 13 wherein the one or more hardware processors is configurable to cause the hardware processing devices to deploy the app within a multitenant environment.

18. The system of claim 1 wherein the one or more hardware processors is configurable to provide one or more lenses within the app, wherein the one or more lenses provide exploration of one or more data sets using one or more fundamental operations including at least measuring, grouping, filtering and viewing, and to provide one or more dashboards within the app, wherein the one or more dashboards provide an interactive interface with information from the one or more lenses.
